(19) United States
(12) Patent Application Publication
(10) Pub. No.: US 2006/0124003 A1
(43) Pub. Date: Jun. 15, 2006

(54) Screen printing machine and printing method thereof

(75) Inventors: Atusi Sakaida, Nagoya-City (JP); Norio Goko, Kariya-City (JP); Toshihisa Taniguchi, Handa-City (JP); Yuji Tuduki, Handa-City (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/299,767

(22) Filed: Dec. 13, 2005

(30) Foreign Application Priority Data
Dec. 13, 2004 (JP) 2004-360357

(51) Int. Cl. B05C 17/04

(52) U.S. Cl. 101/123

(57) ABSTRACT

A printing mechanism 6 of a screen printing machine 1 for printing paste P at a printing position to a work W through a screen S includes a packing nozzle 62 coming into contact, at the distal end thereof, with the screen, a packing head 62 to which the paste consumed during printing is packed and a feed tank 63 for supplying the paste to the filling head. Each of the packing head and the feed tank has therein an extrusion mechanism 62b, 63a and can control an extrusion pressure of the paste to the screen. The printing mechanism further includes a packing head supporting mechanism 64 capable of supporting the packing head in such a manner as to be capable of moving up and down and also capable of regulating the pushing force of the packing head onto the screen.

### BACKGROUND OF THE INVENTION

1. Field of the Invention

This invention relates to a screen printing machine for printing solder paste, etc, onto a substrate through a screen mask and a printing method. More particularly, the invention relates to a screen printing machine that will be suitable for applying screen printing to a high density multi-layered substrate and a printing method.

2. Description of the Related Art

To connect a printed substrate and a semiconductor chip, a connection system called a “flip-chip (FC) bonding system” that uses solder bumps (minute solder protrusions) has generally been used. This system can connect at one time thousands or dozens of thousands of connection points by arranging, plane-wise, semiconductor bumps. With the progress of IT technologies, semiconductor chips have higher functions and the connection conditions of such semiconductor chips require a more minute size, a higher density and a greater number of connection points.

To form the solder bumps, Japanese Unexamined Patent Publication No. 11-48445 discloses a method that uses an apparatus that executes two steps at a work alignment position and a solder printing position, sets a work (substrate) to a work alignment position, moves the work to a solder printing position, then superposes a metal screen mask (hereinafter called “screen”) on the work by using a screen elevation mechanism and prints the solder paste to the work for printing through a squeegee, or the like.

FIGS. 5 and 6 of the accompanying drawings show this screen printing machine according to the prior art. The screen printing machine 1 includes a work alignment mechanism 2 for positioning a work (substrate) W, a work moving mechanism 3 for causing the work W to linearly reciprocate between a work alignment position and a solder printing position, a screen moving mechanism 4 for causing a screen S to linearly reciprocate between the work alignment position and the solder printing machine, a screen elevation mechanism 5 for moving up and down the screen S, a solder bump printing mechanism 6, an image processing camera 7, a camera elevation mechanism 8, and so forth. In this printing machine 1, the work W is put on a table of the work alignment mechanism 2 and is positioned by the work alignment mechanism 2 on the basis of the image taken by the image processing camera 7. Next, the work W is moved to the solder printing position by the work moving mechanism 3 and the screen S is superposed on the work at this solder printing position by the screen elevation mechanism 5. A squeegee 61 of the solder bump printing mechanism 6 is moved and the solder paste P is applied to the work W through the screen S to thereby print the solder bumps B onto the work W.

Generally, a decisive factor of printing quality of the solder bumps is high precision superposition of the screen onto the work and printing accuracy of the solder paste owing to the contact angle θ (packing operation angle) of the screen with the squeegee. As shown in the top view of FIG. 6, the printing head 66 of the solder bump printing mechanism 6 moves on the screen S while clamping the solder paste P by the squeegee 61 and bump printing is conducted onto the work W as shown in FIG. 8A. Incidentally, FIG. 8B shows the screen S on which printing ports S₁ are arranged and the work W to which the bumps B are printed when nine products are acquired from one work W.

In this case, because solder bump printing according to the prior art does not involve printing with high density and a large number of connection points, printing can be conducted while a suitable packing operation angle θ is kept with respect to the lip radius R of the squeegee 61 as shown in FIG. 7A. In a high density multi-layered substrate of the next generation, however, the number of bumps per work is thousands of bumps and is more than ten times the number of the existing bumps that is in the order of hundreds. Therefore, the bump density also reaches a high density of bump diameter φ100×pitch 150 μm.

When the solder bump printing technology according to the prior art is employed to satisfy such a requirement, a suitable packing operation angle θ cannot be kept at a minute bump diameter φ (φ=0.1 mm) corresponding to the lip radius R (R=0.1 mm, for example) in minute bump printing shown in FIG. 7B, and rubbing and printing defects occur.

The thickness t of the screen S has changed from 200 μm of the prior art to 50 μm of a thin film screen with the miniaturization of the bump diameter φ and the problems of floating and positioning error of the screen S with regard to the work occur. Accordingly, printing of the solder bumps to the high density multi-layered substrate has become difficult.

According to the PALAP substrate filed by the present applicant, the substrate material has high wettability with solder unlike the conventional glass-epoxy substrates. Unless the solder is correctly transferred to the bump formation positions, the solder flows during re-flow (because the solder is molten in a non-oxidizing atmosphere to form balls through surface tension) and connects adjacent bumps to invite bridge defects. Therefore, a printing technology not inviting oozing of the solder resulting from floating of the screen is necessary.

### SUMMARY OF THE INVENTION

The invention has been completed in view of the problems described above and is aimed at providing a screen printing machine capable of correctly conducting solder bump printing of a high density multi-layered substrate of the next generation, and a printing method.

According to one aspect of the invention, there is provided a screen printing machine, wherein a printing mechanism for printing paste to a work through a screen mask includes a mechanism having a packing head equipped at its distal end with a packing nozzle coming into contact with the screen mask and moving on the screen mask to thereby conduct printing; and a feed tank for supplying the paste into said packing head; each of the packing head and the feed tank having therein an extrusion mechanism capable of controlling an extrusion pressure of the paste to the screen mask. Accordingly, the paste can be pressurized and discharged very precisely from the packing nozzle and printing of high density minute bumps becomes possible.

In the printing machine according to the invention, the packing nozzle is formed of a material having high rigidity, the packing head is supported by a packing head supporting mechanism capable of moving up and down the packing head and a pushing force of the packing head to the screen mask is adjustable by the packing head supporting mechanism. Accordingly, printing without oozing of the paste from the packing head becomes possible by preventing leakage of the paste from the packing head and floating of the screen mask from the work. The fragile screen mask can be brought into close contact with the work without gaps and printing by using the thin film screen mask becomes possible.

A screen printing method according to another aspect of the invention controls a feed pressure of paste supplied from a packing head to a screen mask and conducts screen printing at a suitable printing pressure. Therefore, the same function and effect as that of the screen printing apparatus described above can be acquired.

The screen printing method according to the invention can regulate the push force of the packing head to the screen mask and can acquire the same function and effect as that of the screen printing apparatus described above.

The present invention may be more fully understood from the description of preferred embodiments of the invention, as set forth below, together with the accompanying drawings.

### BRIEF DESCRIPTION OF THE DRAWINGS

In the drawings:

FIG. 1 is a view showing an overall construction of a screen printing machine according to an embodiment of the invention;

FIG. 2 is an enlarged view of a printing mechanism as a main portion of FIG. 1;

FIG. 3 is an explanatory view for explaining an operation of a packing nozzle according to the invention;

FIGS. 4A, 4B and 4C are explanatory views for explaining the printing operation of the printing machine according to the embodiment of the invention;

FIG. 5 is a view showing an overall construction of a screen printing machine according to the prior art;

FIG. 6 is a three-face view (top view, front view, side view) of a printing mechanism according to the prior art;

FIGS. 7A and 7B are explanatory views for explaining problems of bump printing (FIG. 7A) and minute bump printing (FIG. 7B) according to the prior art; and

FIGS. 8A and 8B are explanatory views for explaining a screen mask (FIG. 8A) and a work that is bump printed (FIG. 8B).

### DESCRIPTION OF THE PREFERRED EMBODIMENTS

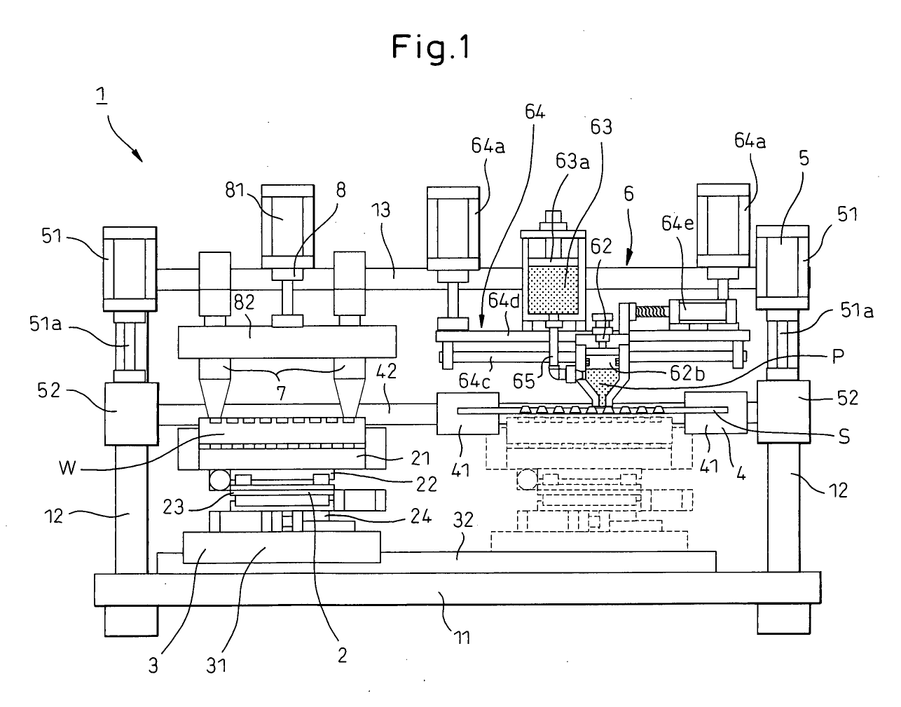

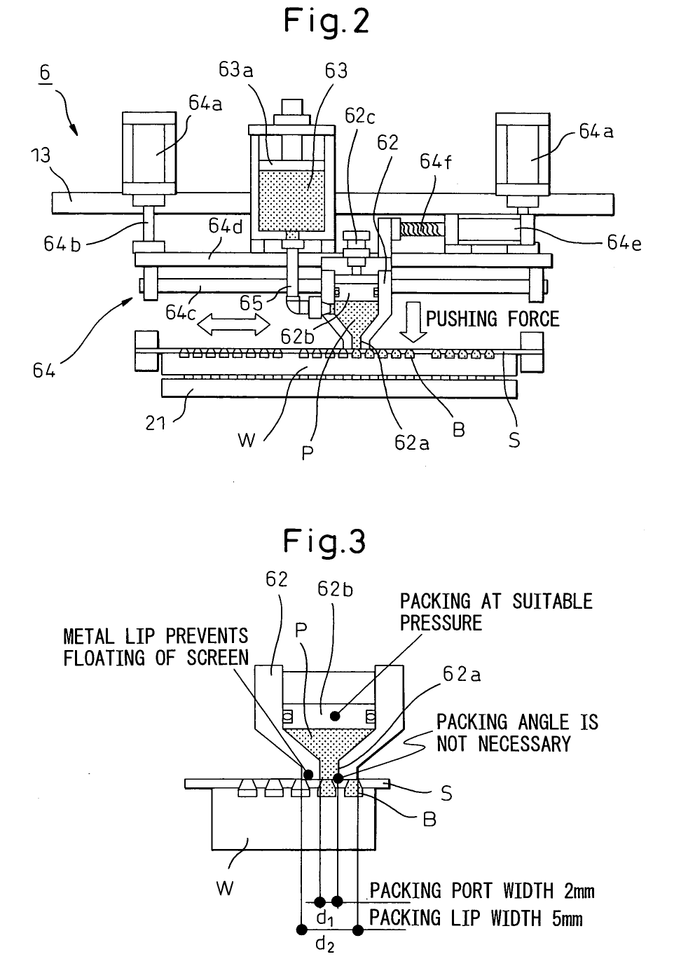

A screen printing machine and its printing method according to embodiments of the invention will be hereinafter explained with reference to the accompanying drawings. FIG. 1 is a view showing an overall construction of a screen printing machine according to the embodiment of the invention and FIG. 2 is an enlarged view of a printing mechanism as a main portion of FIG. 1. The screen printing machine 1 basically includes a work alignment mechanism 2 for positioning a work W as a substrate in X, Y, θ directions, a work moving mechanism 3 for linearly moving the work W between a work alignment position and a printing position, a screen moving mechanism 4 for linearly moving a screen S (screen mask) between the work alignment position and the printing position, a screen elevation mechanism 5 for moving up and down the screen S, a printing mechanism 6 for printing a solder paste P on the work W at the printing position through the screen S, an image processing camera 7 for imaging the work W as well as the screen S, and a camera elevation mechanism 8 for moving up and down the image processing camera 7.

The work alignment mechanism 2 includes a table for supporting and holding the work W, an X direction moving table 22 moving in an X direction, a Y direction moving table moving in a Y direction and a rotary table 24 rotating in a θ direction. These members are combined with one another and are fitted onto a conveyor table 31 of the work moving mechanism 3. The upper surface of the table 21 is an adsorption surface having a large number of suction ports (not shown) and can adsorb and position the work W while the work W is put on the conveyor table 31. These suction ports are connected to a vacuum pump, not shown in the drawings. The table 21 is supported on the X direction moving table 22 and this X direction moving table 22 is supported on the Y direction moving table 23. Furthermore, the Y direction moving table 23 is supported on the rotary table 24. Therefore, the position of the work W on the table 21 can be corrected in the X, Y and θ directions. The movement in the X and Y directions and the rotation in the θ direction are done by servo motors 25.

The work moving mechanism 3 includes a conveyor guide 32 that is disposed on a base 11 of the printing machine 1 and a conveyor table 31 that moves along the conveyor guide 32 while supporting thereon the work alignment mechanism 2. The conveyor 31 is linearly reciprocated between the work alignment position and the printing position along the conveyor guide 32 by a driving unit, not shown in the drawings.

The term “screen S (screen mask)” is a concept that contains those having a predetermined pattern on the surface of a mask such as a metal mask and a screen mask in a narrow sense of the word. This screen S is supported by the screen moving mechanism 4 and reciprocated between the work alignment position and the printing position and also moved up and down by the screen elevation mechanism 5. The screen moving mechanism 4 includes holders 41 for holding the screen S on its both sides and a moving guide 42 bridged between right and left elevation guides 12 implanted on the base 11. The holders 41 holding the screen S are allowed to move in the transverse direction along the moving guide 42 by a driving unit, not shown in the drawing.

The screen elevation mechanism 5 includes a pair of elevation cylinders 51 fitted to the right and left elevation guides 12, respectively, and elevation members 52 for holding the moving guide 42 from both sides, fixed to piston bodies 51a sliding inside the elevation cylinders 51, respectively. The screen elevation mechanism 5 moves up and down the moving guide 42, that is, the screen S. The elevation members 52 are operated by a fluid that is introduced into the elevation cylinders 51, for example.

A transverse mounting 13 is so arranged as to extend between the right and left guides 12 implanted in the base 11 of the printing machine 1. The printing mechanism 6 as the feature of this invention is fitted to the transverse mounting 13. The image processing camera 7 is similarly fixed to the transverse mounting 13 in such a fashion as to be capable of moving up and down but not in the transverse direction. In other words, an elevation cylinder 81 as the camera elevation mechanism 8 is fixed to the transverse mounting 13 and a pair of image processing cameras 7 are fitted to an elevation table 82 fixed to the distal end of a piston 81a that slides inside the elevation cylinder 81. The image processing cameras 7 can recognize the image of the positioning mark of the work W and the positioning mark of the screen S. A control unit (not shown in the drawing) for correcting the table 21 of the work W in the X, Y and θ directions is connected to the image processing cameras 7.

Next, the printing mechanism 6 as the feature of the invention will be explained. The printing mechanism 6 includes a packing head 62 for supplying solder paste P to the work W through the screen S, a feed tank 63 for supplying the solder paste P to the packing head 62 and a packing head supporting mechanism 61 for supporting the packing head 62 and the feed tank 63. The printing mechanism 6 does not have a squeegee that is provided to the prior art. The packing head supporting mechanism 64 includes a pair of elevation printing cylinders 64a fixed to the transverse mounting 13 in a spaced-apart relation, first and second guides 64c and 64d supported by a piston 64b sliding inside the pair of elevation printing cylinders 64a, a moving printing cylinders 64e fitted onto the second guide 64d and a moving body 64f sliding inside the moving printing cylinder 64e.

The packing head 62 includes a packing nozzle 62a the distal end of which comes into contact with the screen S, a first extrusion mechanism 62b for extruding the solder paste P packed therein from the packing nozzle 62a and a fluid introduction port 62c for pushing the first extrusion mechanism 62b at the rear end. The packing head 62 is movably supported by a first guide 64c and is coupled to a moving body 64f of the moving printing cylinder 64e. Therefore, the packing head 62 moves in the transverse direction along the first guide 64c owing to the operation of the moving printing cylinder 64e. The packing nozzle 62a is formed of a material having high rigidity such as a metal or ceramic. Because the contact surface with the screen S has high planarity and chamfering of the open portion of slits does not exit as shown in FIG. 3, a packing operation angle θ of a rubber squeegee or a metal blade according to the prior art is not disposed. The packing nozzle 62a has a slit having a minute gap such as a packing port width d₁ of 2 mm and a packing lip width d₂ of 5 mm and a width D equal to the width of a print surface of the work such as 500 mm. When a pressure of a fluid introduced from the introduction port 62c into the packing head 62 is changed, the extrusion pressure of the solder paste P by the first extrusion mechanism 62b can be controlled.

The feed tank 63 has a capacity greater than that of the packing head 62 and includes therein a second extrusion mechanism 63a similar to the packing head 62. The feed tank 63 and the packing head 62 are communicated with each other by a communication pipe 65 and a suitable amount of the solder paste P is appropriately supplied from the feed tank 63 to the packing head 62 by the pushing operation of the second extrusion mechanism 63a. The feed tank 63 is supported in such a fashion as to reciprocate on the second guide 64d and both packing head 62 and feed tank 63 together move along the first guide 64c or the second guide 64d by the operation of the moving printing cylinder 64e.

Both ends of each of the first and second guides 64c and 64d are supported by the piston bodies 64b of the pair of elevation printing cylinders 64a and can move up and down. Therefore, both packing head 62 and feed tank 63 move up and down. In this way, the packing head supporting mechanism 64 of the packing head 62 and the feed tank 63 can reciprocate the packing head 62 and the feed tank 63 in the transverse direction and can also move them in the vertical direction. Consequently, the packing head supporting mechanism 64 can control the push force of the packing head 62 to the screen S by adjusting the descending distance by the elevation printing cylinder 64a.

As described above, in the printing mechanism 6, the work W is held at the printing position at which the screen S is superposed as shown in FIG. 2 and the packing head 62 is pushed by the packing head support mechanism 64 at a suitable pressure such as 150 kPa to the printing position of the screen S. The solder paste P consumed during printing is supplied and packed from the feed tank 63 to the packing head 62 and printing of one or more time can be made. The packing head 62 is fitted by the moving printing cylinder 64e to the packing head supporting mechanism 64 in such a fashion as to be capable of moving to the right and left on the screen S and prints the entire surface of the work when the moving printing cylinder 64e is operated.

The invention employs the system in which the paste feed pressure of the screen S to the printing port S1 is controlled by the push pressure of the first extrusion mechanism 62b arranged on the packing head 62. The invention employs also the system that prevents leak of the paste from the packing head 62 and float of the screen S from the work W by the push-down pressure of the packing head supporting mechanism 64. In this way, the invention employs the construction capable of individually optimizing the suitable pressure of printing and the holding condition of the screen S.

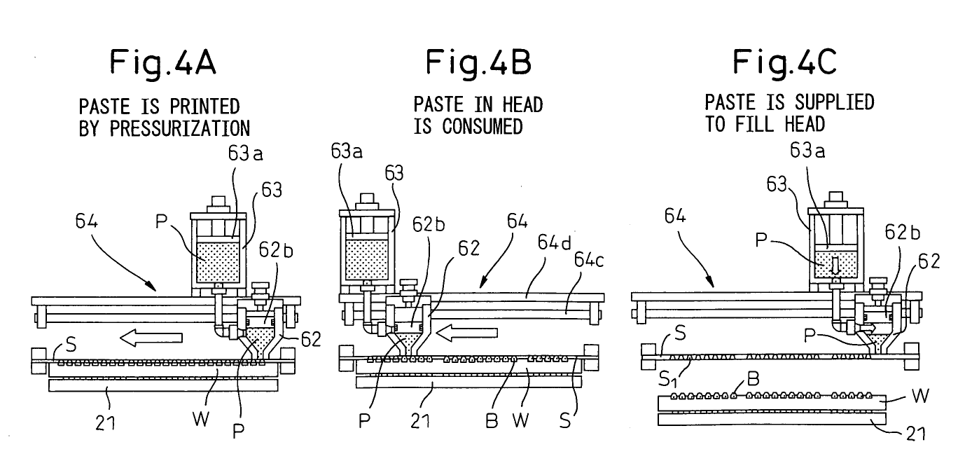

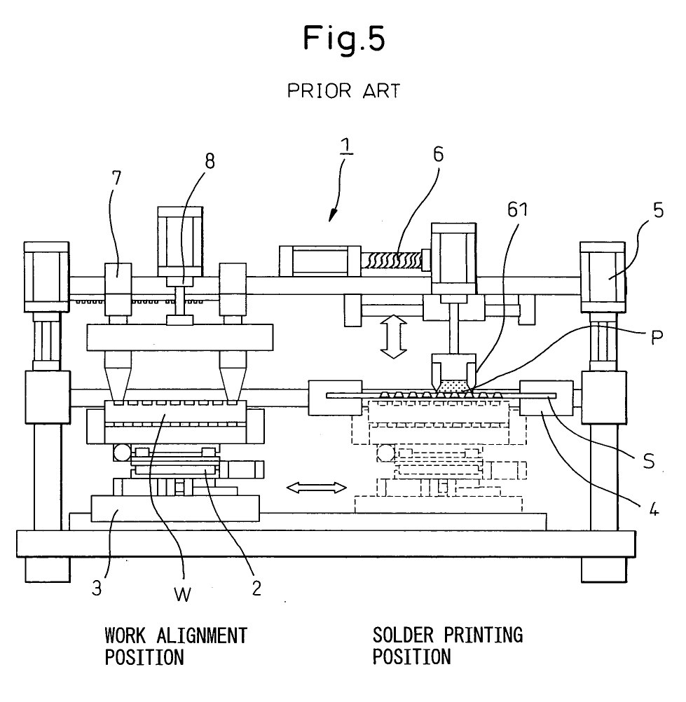

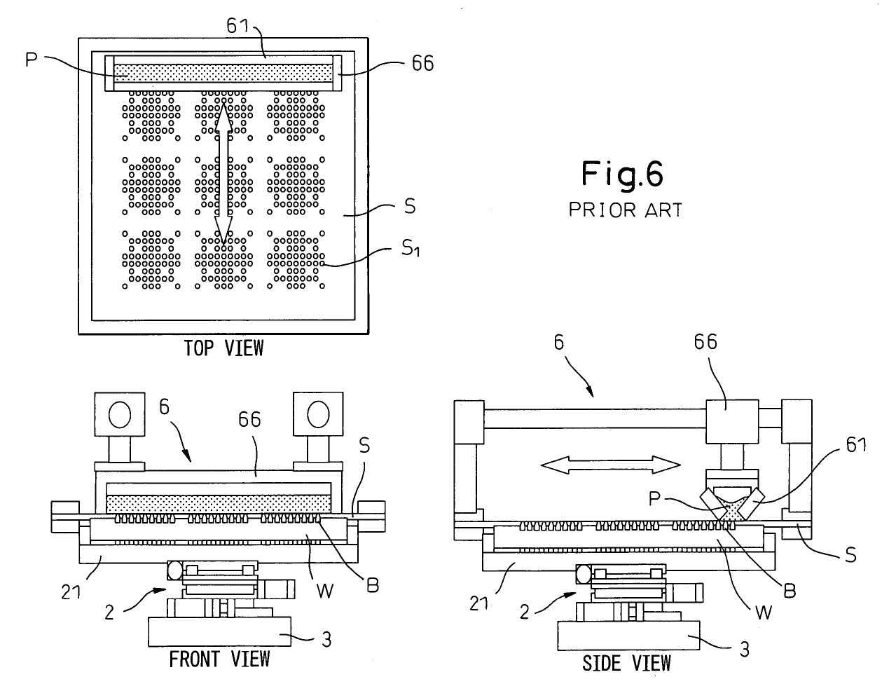

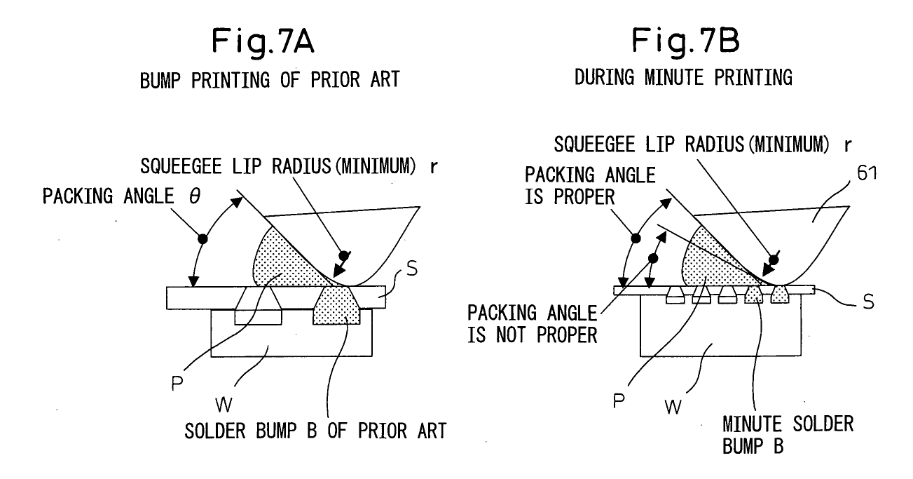

The operation of the screen printing machine 1 of this embodiment having the construction described above will be explained with reference to FIG. 4. Incidentally, in the printing machine 1 according to the invention, too, the alignment operation of the work W is carried out at the work alignment position in the same way as in the ordinary printing machines and the later-appearing printing operation is carried out at the printing position. In other words, this printing machine 1 conducts three steps of printing operations as shown in FIGS. 4A to 4C. Referring to FIG. 4A, the second extrusion mechanism 63a of the feed tank 63 is fixed and the first extrusion mechanism 62b disposed inside the packing head 62 is operated at 50 kPa, for example. Then, the solder paste P is uniformly extruded from the slit (2 mm×500 mm, for example) of the packing nozzle 62a and fills the printing ports S1 of the screen S. The moving printing head 64e of the packing head supporting mechanism 64 is operated and the packing nozzle 72a moves on the screen S at 20 mm/s, for example, and smoothes the solder paste P to execute printing of the solder bumps B.

Printing of the solder bumps B is finished when the solder paste P inside the packing head 62 is consumed by printing as shown in FIG. 4B. Next, to prepare for printing of the next cycle, the work W is removed from the screen S and the second extraction mechanism 63a of the feed tank 63 is operated as shown in FIG. 4C and the solder paste P is supplied from the feed tank 63 to the packing head 62. The amount of the solder paste inside the packing head 62 is returned to the initial state.

Printing of high precision minute solder bumps B can be done in the manner described above.

In the embodiment described above, the paste capacity inside the packing head 62 has the capacity for one cycle but the packing head 62 can have a capacity of one or more cycles.

The first and second extrusion mechanisms 62b and 63a inside the packing head 62 and the feed tank 63 are shown having a piston-like shape in the drawings but they may be a membrane-like extrusion mechanism.

Printing quality can be further improved by disposing a cleaning station (wiping mechanism by clean paper, etc), not shown, and washing the end face of the packing nozzle 62a when the solder paste P is supplied from the feed tank 63 to the packing head 62.

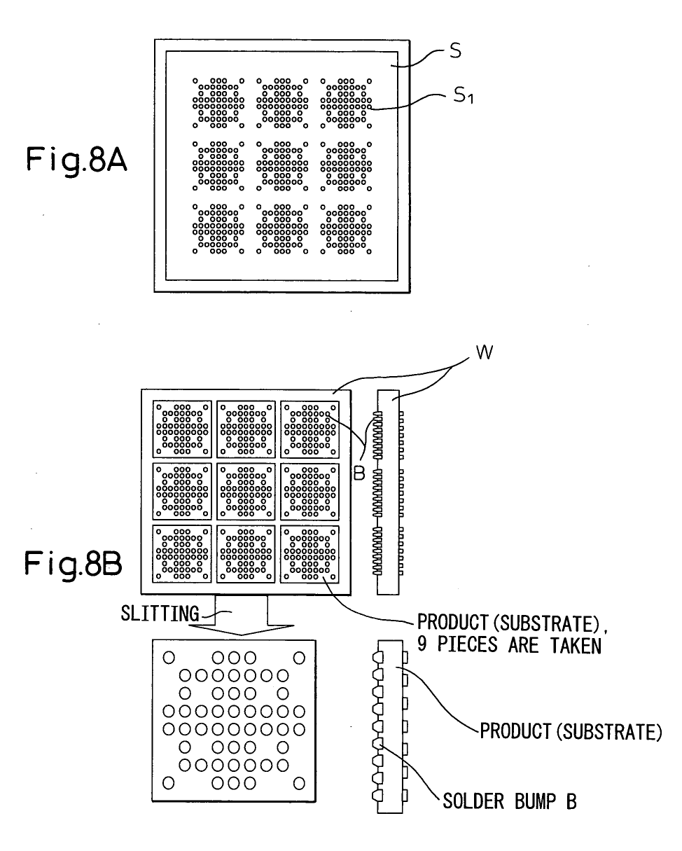

The slit of the packing nozzle 62 explained above has the size of 2 mm×500 mm but printing quality can be further improved by adapting the size of the slit in accordance with the thickness of the screen. As to the shape of the slit, a slit that is divided into three slits in accordance with the printing width can be disposed in the case of works of three sets shown in FIG. 8B without limiting the slit to one. In this way, printing quality can be improved.

As explained above, according to the invention, the packing head having the packing nozzle for pressuring and discharging very precisely the paste and the paste feed tank for supplementing the paste to this packing nozzle and the pressurization mechanism (packing head supporting mechanism) for the screen that uses this packing head are mounted. Consequently, optimization of the printing pressure that has not been possible by squeegee type printing according to the prior art becomes easy and printing of high quality minute shapes can be made with high productivity. Furthermore, printing of a thin film screen with miniaturization becomes possible.

While the invention has been described by reference to specific embodiments chosen for purposes of illustration, it should be apparent that numerous modifications could be made thereto by those skilled in the art without departing from the basic concept and scope of the invention.

1. A screen printing machine for superposing a screen mask, having formed thereon a predetermined pattern, on a work to which a predetermined pattern is to be printed and applying printing paste onto said work through said screen mask, wherein a printing mechanism includes:
a packing head having a packing nozzle coming into contact, at a distal end, with said screen mask and moving on said screen mask to thereby conduct printing; and
a feed tank for supplying said paste into said packing head;
each of said packing head and said feed tank having therein an extrusion mechanism capable of controlling an extrusion pressure, of said paste, onto said screen mask.

2. A screen printing machine according to claim 1, wherein said packing nozzle is formed of a material having high rigidity, said packing head is supported by a packing head supporting mechanism capable of moving up and down said packing head and a pushing force of said packing head to said screen mask is adjustable by said packing head supporting mechanism.

3. A screen printing method including the steps of putting a work on a table, positioning said work by a work alignment mechanism on the basis of the image taken by a camera at a work alignment position, then moving said work to a printing position and applying paste by a printing mechanism to said work through a screen mask to thereby conduct printing, comprising the steps of:
controlling a feed pressure of said paste supplied from a packing head of said printing mechanism to said screen mask; and
conducting screen printing at a suitable printing pressure.

4. A screen printing method according to claim 3, wherein the pushing force of said packing head to said screen mask is adjustable.
